(19) United States
(12) Patent Application Publication
(10) Pub. No.: US 2017/0200227 A1
(43) Pub. Date: Jul. 13, 2017

(54) SYSTEM FOR ANALYZING ELECTRONIC LEGAL INVOICE DATA

(71) Applicant: ITIP Development, LLC, Fort Gratiot, MI (US)

(72) Inventor: Thomas F. QUINN, Lexington, MI (US)

(21) Appl. No.: 15/313,778

(22) PCT Filed: May 29, 2015
(86) PCT No.: PCT/US15/33272

§ 371 Date: Nov. 23, 2016

Related U.S. Application Data
(60) Provisional application No. 62/004,476, filed on May 29, 2014.

(51) Int. Cl. G06Q 40/04; G06F 17/18; G06Q 30/04

(52) U.S. Cl. CPC G06Q 40/04; G06Q 30/04; G06F 17/18

(57) ABSTRACT

Systems and methods analyze electronic invoice data. The system accesses invoice data stored in memory. The invoice data includes a matter identifier with service charges and service dates. The system also identifies a target date associated with the matter identifier and a service associated with the target date. The system also accesses service time period data stored in the memory for the identified service. The system also calculates a service start date and a service end date based on the service time period data and the target date. The system also identifies from the invoice data the service charges between the service start date and the service end date. The system also stores a record in the memory to correlate the service with each of the identified service charges between the service start date and the service end date. Resulting data can be summed together, averaged over multiple services, and benchmarked for different service providers.

### CROSS-REFERENCE TO RELATED APPLICATIONS

This application claims the benefit of U.S. Provisional Application No. 62/004,476 filed on May 29, 2014, which is incorporated by reference herein in its entirety.

### TECHNICAL FIELD

The present invention generally relates to analyzing invoice data for legal services, and more particularly relates to a system and method for identifying specific legal services and analyzing charges relating thereto.

### BACKGROUND

There is a growing pressure for corporate counsel to implement cost savings initiatives, particularly when external legal services provided by outside counsel to corporate clients are becoming more and more expensive. As a result, many companies have implemented e-billing systems that receive and store legal invoice data in an electronic format. Data is often provided in a uniform electronic format, such as LEDES 98B or the like. Invoice data submitted to e-billing systems includes conventional data for each line item charge on an invoice, for example, the invoice number, invoice date, charge amount, matter number, timekeeper, service types, expense types, etc. are provided for each line item found on a conventional paper invoice. By gathering invoice data in an electronic format in an e-billing system, such data is available for analysis to determine cumulative costs for various services provided over the life of legal matters. Theoretically, with invoice data in an electronic format, charges for certain service types can be segregated and analyzed.

Service types, sometimes referred to as task codes or activity codes, are used in e-billing systems to segregate charges for a variety of legal services provided throughout the life cycle of individual legal matters. UTBMS service types and expense types are one standardized, conventional set of service type and expense type codes. Unfortunately, in complicated legal matters such as international patent prosecution matters, service types are often used in a very inconsistent manner, making it difficult or impossible to accurately analyze invoice data in an e-billing system. Industry experts believe over one third of service types and expense types are improperly used. Two common reasons service types are improperly used are as follows. First, billing administrators are commonly given the responsibility of inserting service types into e-billing data and often they simply do not understand the substantive legal services being performed by the attorneys. As a result, billing administrators use incorrect service types when submitting invoice data into the client's e-billing system. Second, outside counsel may intentionally use incorrect service types or expense types.

In addition, patent prosecution typically occurs over very protracted periods of time in a variety of countries. It is not uncommon for patent prosecution to take more than five years in many patent offices. This also makes it difficult to analyze cost data because data must be gathered over a very long period of time to capture cost data throughout the life cycle of one patent matter. Exchange rate fluctuations, changes in billing rates and attorney turn over during this period of data gathering can cause data to become quite skewed. When these factors are combined with invoice data that has been coded with inaccurate service types, any analysis of the invoice data becomes suspect at best.

### SUMMARY

Embodiments of the present invention overcome the above identified shortcomings of conventional technologies. In accordance with one aspect of the present invention, a system is provided for analyzing electronic invoice data related to intellectual property matters. The system has process circuitry for storing data and executing a variety of routines. Invoice data is stored within said process circuitry comprising service charges, service dates, expense charges, expense dates, and matter identifiers. Fee data is stored within said process circuitry comprising a minimum fee and a maximum fee. An identifying routine is executed to identify target expense dates for target expense charges having a total between said minimum fee and said maximum fee. Service time period data is stored within said process circuitry. A date range calculating routine is executed to calculate a service start date and a service end date based upon said service time period data and said target expense dates. An analysis routine is executed to identify said service charges for at least one of said matter identifiers having said service dates between said service start date and said service end date.

According to another aspect of the present invention, a system is provided for analyzing electronic invoice data related to intellectual property matters. The system has a process circuitry for storing data and executing a variety of routines. Invoice data comprising service charges, service dates and matter identifiers is stored within the process circuitry. Docketing data comprising matter identifiers and at least one target date for said intellectual property matters is also stored in the process circuitry. Service time period data is also stored within said process circuitry. A date range calculating routine is executed to calculate a service start date and a service end date based upon the service time period data and the target date. An analysis routine is executed to identify the service charges for at least one of the matter identifiers having service dates between the service start date and the service end date. Other embodiments of systems are also disclosed.

In another embodiment, a computer program product includes a non-transitory computer readable storage medium to store a computer readable program. When the program is executed by a processor within a computer, the computer readable program causes the computer to perform operations for analyzing electronic invoice data. In one embodiment, the operations include accessing invoice data stored in memory. The invoice data includes a matter identifier with service charges and service dates. The operations also include identifying a target date associated with the matter identifier and a service associated with the target date. The operations also include accessing service time period data stored in the memory for the identified service. The operations also include calculating a service start date and a service end date based on the service time period data and the target date. The operations also include identifying from the invoice data the service charges between the service start date and the service end date. The operations also include storing a record in the memory to correlate the service with each of the identified service charges between the service start date and the service end date.

In another embodiment, a method is provided for analyzing electronic invoice data. In one embodiment, the method includes accessing invoice data stored in memory. The invoice data includes a matter identifier with service charges and service dates. The method also includes identifying a target date associated with the matter identifier and a service associated with the target date. The method also includes accessing service time period data stored in the memory for the identified service. The method also includes calculating a service start date and a service end date based on the service time period data and the target date. The method also includes identifying from the invoice data the service charges between the service start date and the service end date. The method also includes storing a record in the memory to correlate the service with each of the identified service charges between the service start date and the service end date. Other embodiments of methods are also disclosed.

In another embodiment, a computer program product includes a non-transitory computer readable storage medium to store a computer readable program. When the program is executed by a processor within a computer, the computer readable program causes the computer to perform operations for estimating lifetime cost of a service. In one embodiment, the operations include identifying a first cost for a discrete first service. The first cost is derived from an actual cost record associated with the first service. The operations also include identifying a second cost for a discrete second service. The second cost is derived from an actual cost record associated with the second service. The operations also include performing a mathematical computation to combine the first cost and the second cost into a combined cost estimate. The operations also include presenting the combined cost estimate to a user as an estimated cost of a service matter in which completion of the service matter is anticipated to include stages comparable to the discrete first and second services. Other embodiments of computer program products are also disclosed.

These and other aspects, objects, and features of the present invention will be understood and appreciated by those skilled in the art upon studying the following specification, claims, and appended drawings.

### BRIEF DESCRIPTION OF DRAWINGS

In the drawings:

FIG. 1 is an illustration of a system for storing invoice data and for managing the costs of legal services;

FIG. 2 is a time line diagram of the life cycle for patent prosecution, illustrating the legal service performed and official patent office fees associated with such services;

FIG. 3 is a time line diagram of the life cycle for patent prosecution, illustrating exemplary time periods associated with legal services performed, the dates related to the associated payment of official patent office fees and the docketing dates associated with payment of such fees;

FIG. 4 is a time line diagram of the life cycle for patent prosecution, illustrating exemplary selected time periods associated with legal services performed and dates related to the associated payment of official patent office fees;

FIG. 5 is an exemplary flow chart diagram of one embodiment of a method for implementing routines to generate more accurate billing designations;

FIG. 6 is a schematic block diagram of one embodiment of a system for analyzing electronic invoice data; and

FIG. 7 is a schematic block diagram of one embodiment of a computer architecture to implement the system of FIG. 6.

### DETAILED DESCRIPTION

Various aspects of the system and method of the present invention disclosed herein, along with the accompanying drawings referenced herein, are intended to be exemplary and not limiting. It is understood that other embodiments may be utilized and fall within the scope of the appended claims without departing from the spirit of the invention.

It would be desirable to accurately segregate charges for certain services with little or no reliance on service types, expense types or the descriptions of charges in a billing system. It would be even more desirable to accurately segregate charges for certain services in an automated fashion with little or no reliance on service types, expense types or the descriptions of charges. Existing billing systems do not provide these capabilities and rely solely upon manually entered service types and expense types to segregate services provided on individual matters.

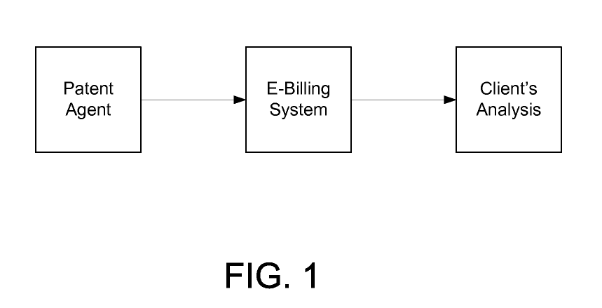

Referring to FIG. 1, a system for analyzing invoice data is shown. E-billing systems are capable of receiving and storing invoice data in a variety of conventional formats. In particular, the common components of conventional paper invoices for legal services are provided in a standardized electronic format such as LEDES 98B. Each line item charge in a conventional paper invoice is included in the electronic invoice data for entry into the e-billing system. For example, a $500 service charge for responding to an office action that is provided in LEDES 98B format, and the information related to that charge, can include about 25 fields of data. The more recognizable data fields include the client name, invoice number, invoice date, invoice total, matter number, service type, expense type, charge amount, currency, charge description, charge date, timekeeper, charge rate, number of units, service type and expense type. A full description of LEDES data formats can be found at the web site www.ledes.org and a full description of UTBMS Service Types and Expense Types used in LEDES data can be found at the American Bar Association web site: www.americanbar.org, which are both incorporated herein by reference. One should note that while the information used by the system can be derived from conventional e-billing systems, invoice data can also be obtained from other sources such as databases, OCR invoices, or other electronic invoice data sources.

As shown in FIG. 1, for patent matters, a patent agent enters data into the system. Once invoice data is entered into the system, a client can analyze charges for a particular matter by summing and categorizing charges for the matter by service type or expense type. The only issue with this technique is that if the service types are not accurate for the matter, the sums are not accurate and the charges cannot be accurately categorized. Since traditional e-billing systems rely upon outside counsel to provide service types for their charges, such systems have proven to be ineffective for accurately receiving and analyzing the invoice data on a consistent basis. Moreover, the only way to determine if a service type has been accurately used is to check the charge description to make sure the described services match the service type. Unfortunately, charge descriptions are not uniform and it is often difficult to accurately determine what service was performed and therefore what service type should be used. Moreover, a timekeeper may intentionally use an incorrect service type and provide misleading charge descriptions in order to avoid a client being able to detect high charges on a particular matter. As such, it is difficult or impossible to generate accurate benchmarking reports from a conventional e-billing system, which compare the charges of multiple legal service providers for various legal services, particularly for intellectual property matters.

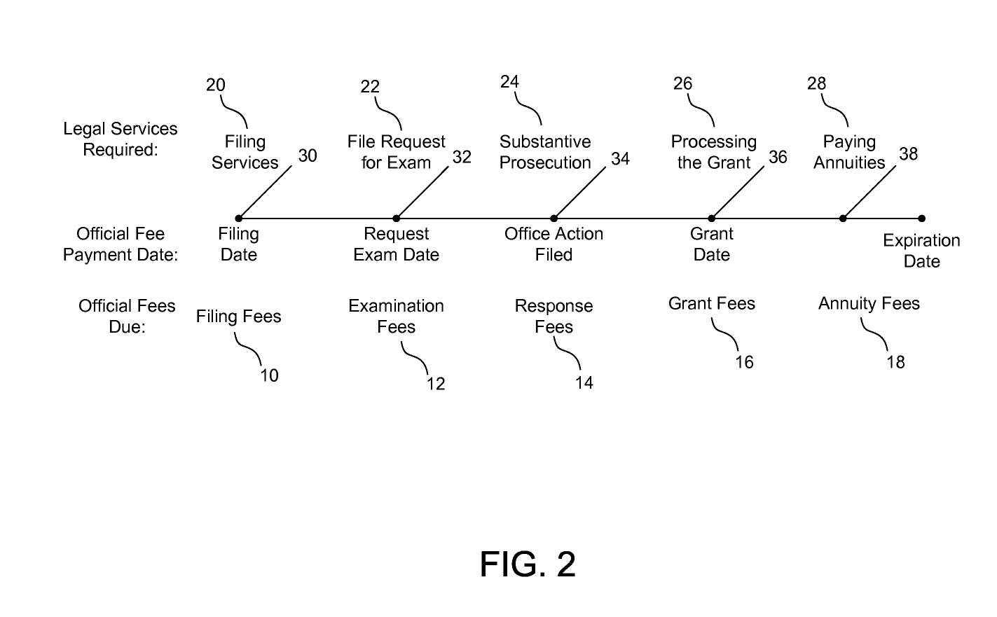

In order to reduce or avoid the necessity of using service types to identify charges that relate to a particular service, the present invention utilizes unique methods and systems to take the inaccurately coded invoice data with inaccurate descriptions of the services that were performed, and transform it such that the system can accurately determine what legal services were performed as well as the charges associated with those legal services. For example, the life cycle of patent prosecution services are often protracted over several years. As shown in FIG. 2, there are distinct services performed in close proximity to milestone dates during the prosecution process. These milestone dates are directly associated with official fees paid to the applicable patent offices. By identifying the official fees in the invoice data, the date of payment or a date relating thereto can be determined with reasonable accuracy. By determining a date relating to the official fee payment, it is possible to define a time period relative to that date when specific legal services were performed. Once the applicable time period is defined, charges during the time period can be identified and analyzed.

In some embodiments, an improved system facilitates the generation of more accurate information that is derived from target data, rather than from e-billing designations that are coded, described and submitted by a service provider. While the e-billing designations from the service provider may be input into the system, some embodiments of the system separately generate billing information that is not necessarily derived from the service provider's submitted e-billing information. Instead of using the service provider's submitted e-billing information, the system accesses expense data and/or docketing data to identify specific target events with known or established working timeframes associated with each type of event.

Based on the type of target event and the working timeframe associated with the target event, other billing activities that fall within the associated working timeframe can be designated as correlating to the identified event, regardless of the types of e-billing codes or billing descriptions that are submitted by the service provider. In other words, the system can use newly generated billing information, derived from identifiable expense or docketing events, to establish a new expense profile that is independent of the service provider's records.

As one example, the actual date of an incurred expense may provide a target event around which a working window can be established, and services provided within that working window can be designated as corresponding to the activity directly associated with the incurred expense. In another example, the actual date of a filing deadline or filing date may provide a target event around which the working window can be established, and services provided within that working window can be designated as corresponding to the activity directly associated with the filing deadline or filing date. In this way, the billing designations become tied to a particular target event (expense date or docket date), rather than simply coded with an e-billing code or descriptions of services that otherwise may have no relationship with the target event.

The newly established billing designations may be communicated to a user in a variety of ways, including through reports, graphs, and other visual indications or displays. Additionally, in some embodiments the newly established billing designations may be used to compare against the service provider's submitted e-billing data. In the case of any discrepancies between the newly established billing designations and the service provider's submitted e-billing data, warnings or flags may be used to notify a user of the system that such discrepancies exist. In some embodiments, the service providers may be automatically notified of such discrepancies, with the expectation that the service providers will reconsider and confirm or revise the flagged e-billing data.

A more detailed discussion of the system and method of the present invention follows, including automated techniques to identify official fees and their associated payment dates, as well as how to define time periods related to such payment dates and how to analyze charges during these time periods with little or no reliance upon service type codes or inaccurate service descriptions. This detailed discussion below demonstrates how raw data that has inaccurately coded service types and has inaccurate service descriptions can be transformed into data that is accurately associated with a specific service being performed, without the need for accurate service types or accurate descriptions of the work being performed.

As shown in FIG. 2 and described as follows, the life cycle of patent prosecution and maintenance includes a variety of official fees charged by the applicable patent office. These official fees are typically fixed and are due at specific points during prosecution. In most countries, the majority of charges associated with patent prosecution are “professional fees” or “service fees”, which are charges for services performed by patent professionals. In most countries the largest out of pocket expense or disbursement by these patent professionals is typically official fees.

As also shown in FIG. 2, official fees are due throughout the life cycle of the patent. For example, when the application is filed in a patent office, “filing fees” 10 are paid at the time of filing or shortly thereafter. In some countries the patent office will not examine the patent application until a request for examination is made and the applicable “examination fee” 12 is paid. In some countries, when a response to an office action is filed, a “response fee” 14 must be paid. If and when the patent application is ultimately granted, a “grant fee”, “issue fee” or “registration fee” 16 is due to be paid to the patent office. After the application has granted, “annuity fees” 18 are typically due on various anniversaries after filing or after the grant and are sometimes also referred to as “renewal fees” or “maintenance fees”. Note, some annuity fees are due prior to the grant date.

When each of the above official fees are paid, there are often specific services required, which are performed prior to and/or just after the official fee is paid. For example, when the filing fees are paid, there are filing services 20 required to actually file the application. For a priority application, these fees are associated with, for example, inventor interviews, drafting the application, and filing the application. For secondary international filings, these filing services 20 may include filling out the paper work needed for filing, in some cases a translation of the application is needed, preparing a voluntary amendment and filing the application with the patent office. When examination fees are paid, services are required to file a request for examination 22 and other related services. When a response fee is paid, substantive prosecution services 24 are performed in advance of the response fee for preparing the response. When the grant fee is paid, services are required to process the grant 26, including checking the granted application, paying the grant fee and performing other related services. When annuity fees are paid, services are required to pay the annuities 28 and perform other related services. The present invention includes embodiments of methods and a system for analyzing electronic invoice data to identify dates associated with the payment of these official fees so that service charges during various time periods relating to the official fees can be identified and measured.

An embodiment of the system of the present invention is embedded in conventional process circuitry which can be implemented as a computer having a microprocessor and memory. It should be appreciated that any analog and/or digital process circuitry may be employed to process the data, execute one or more routines and handle communications. Memory may include volatile and/or non-volatile memory including, but not limited to, random access memory (RAM), read-only memory (ROM), electronically erasable programmable read-only memory (EEPROM), flash memory and other known memory storage mediums. Stored within memory are a number of routines and data. The routines may be executed by the microprocessor.

Also, many of the functional units described in this specification have been labeled as routines or modules, in order to more particularly emphasize their implementation independence. For example, a routine or module may be implemented as a hardware circuit comprising custom VLSI circuits or gate arrays, off-the-shelf semiconductors such as logic chips, transistors, or other discrete components. A routine or module may also be implemented in programmable hardware devices such as field programmable gate arrays, programmable array logic, programmable logic devices or the like.

Routines or modules may also be implemented in software for execution by various types of processors. An identified routine or module of executable code may, for instance, comprise one or more physical or logical blocks of computer instructions which may, for instance, be organized as an object, procedure, or function. Nevertheless, the executables of an identified routine or module need not be physically located together, but may comprise disparate instructions stored in different locations which, when joined logically together, comprise the routine or module and achieve the stated purpose for the routine or module.

Indeed, a routine or module of executable code may be a single instruction, or many instructions, and may even be distributed over several different code segments, among different programs, and across several memory devices. Similarly, operational data may be identified and illustrated herein within routines or modules, and may be embodied in any suitable form and organized within any suitable type of data structure. The operational data may be collected as a single data set, or may be distributed over different locations including over different storage devices.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “routine,” “module,” or “system.”

It will be appreciated that in some configurations, some or all of the software is stored in a non-transitory state such that the software, or representations thereof, persist in the same physical location for a period of time. Additionally, in some configurations some or all of the software is stored on one or more non-transitory storage devices, which include hardware elements capable of storing non-transitory states and/or signals representative of the software, even though other portions of the non-transitory storage devices may be capable of altering and/or transmitting the signals. Examples of a non-transitory storage devices includes, but are not limited to read-only memory (ROM), random access memory (RAM), flash memory, magnetic disks, optical disks, integrated circuits, flip-flops and other logical state devices, and so forth. Each of these non-transitory storage devices can store signals and/or states representative of the software portions for a period of time. However, the ability to store the signals and/or states is not diminished by further functionality of transmitting signals that are the same as or representative of the stored signals and/or states. For example, a processor may access the non-transitory storage device to obtain signals that are representative of the stored signals and/or states in order to execute the corresponding software instructions.

Furthermore, the present invention may take the form of a computer program product on a computer-usable storage medium having computer-usable program code embodied in the medium. Any suitable computer usable or computer readable medium may be utilized. The computer-usable or computer-readable medium may be, for example but not limited to, an electronic, magnetic, optical, electromagnetic, or semiconductor system, apparatus, device, etc. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute on a special purpose data processor, a general-purpose computer, a computer system, or a group of networked computers or computer systems configured to perform the steps or modes of the methods of the invention. The processor or computer used to execute the program code may be connected to one or more user computer(s), phone(s), or other mobile device(s) through, for example, the Internet using an Internet Service Provider.

Conventional invoice data can be stored within the process circuitry. This invoice data can be from one or more agents and one or more countries and can include, but is not limited to, service charges, service dates, expense charges, expense dates, matter identifiers, country identifiers, agent names, expense types, service types, descriptions of services, descriptions of expenses and the like.

Docketing data related to intellectual property matters can also be stored within the process circuitry. For example, conventional docketing data as used by IP practitioners may be included therein. Alternatively, the system can access data related to intellectual property matters from the process circuitry of other systems such as conventional IP management systems (e.g., matter management or docketing systems provided by Anaqua, Lecorpio, Computer Patent Annuities, Computer Packages Inc., Thomson Reuters, and the like) or publicly available data such as that provided by various patent offices or other information providers. The phrase “conventional docketing data” will be used to describe all of these examples of data sources as well as others known in the art. The data related to intellectual property matters can include, but is not limited to, matter identifiers, country identifiers, filing dates 30, filing deadline dates, examination dates 32, examination deadline dates, response dates 34, response deadline dates, grant dates 36, grant deadline dates, annuity dates 38 and annuity deadline dates. Other docketing dates such as PPH deadline dates, PPH dates and the like may also be included.

The system may also store a variety of time period data. Time period data can include time parameters that are associated with various data such as official fee payments and the typical periods of time when legal services relating to such official fees are usually performed and completed. For example, for filing services time period data is the typical window of time or “time period” that filing services 20, related to the filing of an intellectual property application, are completed. In addition, filing services time period data can also include data that relates this time period to an applicable date such as the filing date 30 or the official filing fee expense date, the official filing fee due date or the date the official filing fee was actually paid.

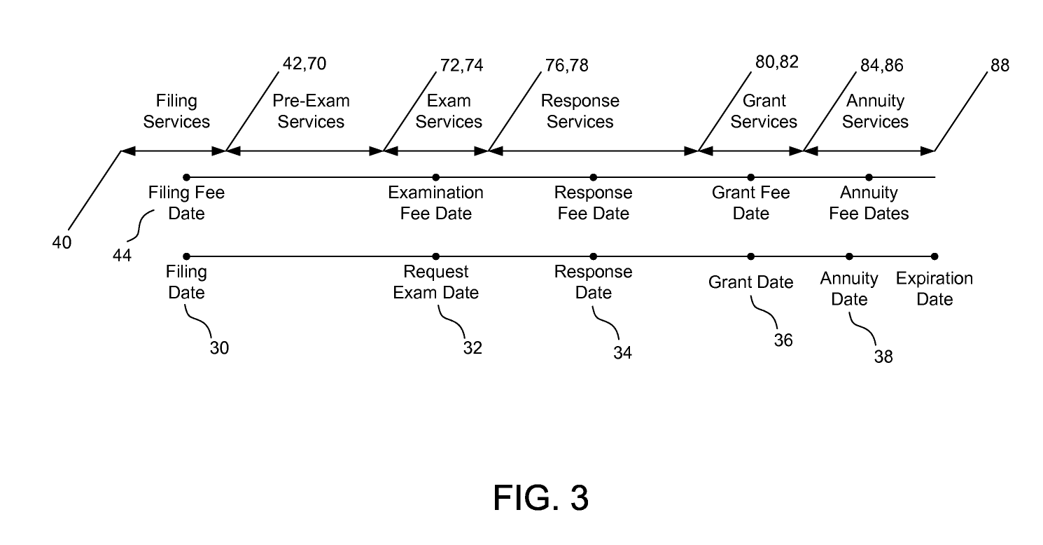

As shown by example in FIG. 3, the filing services time period begins with a filing service start date 40 and a filing service end date 42. The filing service start date 40 is selected to be a predetermined amount of time in advance of the official filing fee date 44, or the actual filing date 30. Likewise, the filing service end date 42 is selected to be a predetermined amount of time after the official filing fee date 44, or the actual filing date 30. These predetermined amounts of time in advance of, and after, the official filing fee date 44 or actual filing date 30 are established based upon a variety of factors, such as the country where the intellectual property application is being filed, the legal services required for filing in that country and the typical length of time taken by agents to complete the filing services required. These factors are best determined by reviewing relevant invoice data for a variety of agents in a variety of circumstances in order to establish reliable, typical time period data for the applicable country, or specific time period data for a particular agent, but other methods may also be used. As further shown by example in FIG. 3, time period data can also include pre-examination services time period data (e.g., services relating to EPC Rule 161), examination services time period data and grant services time period data, which are determined in the same manner as the filing service time period data example above. In addition, selected time period data can be entered into the system. Selected time period data may relate to an official fee date or other dates, depending on the desired time period, where services and charges are to be analyzed. As such, time period data to be customized as needed.

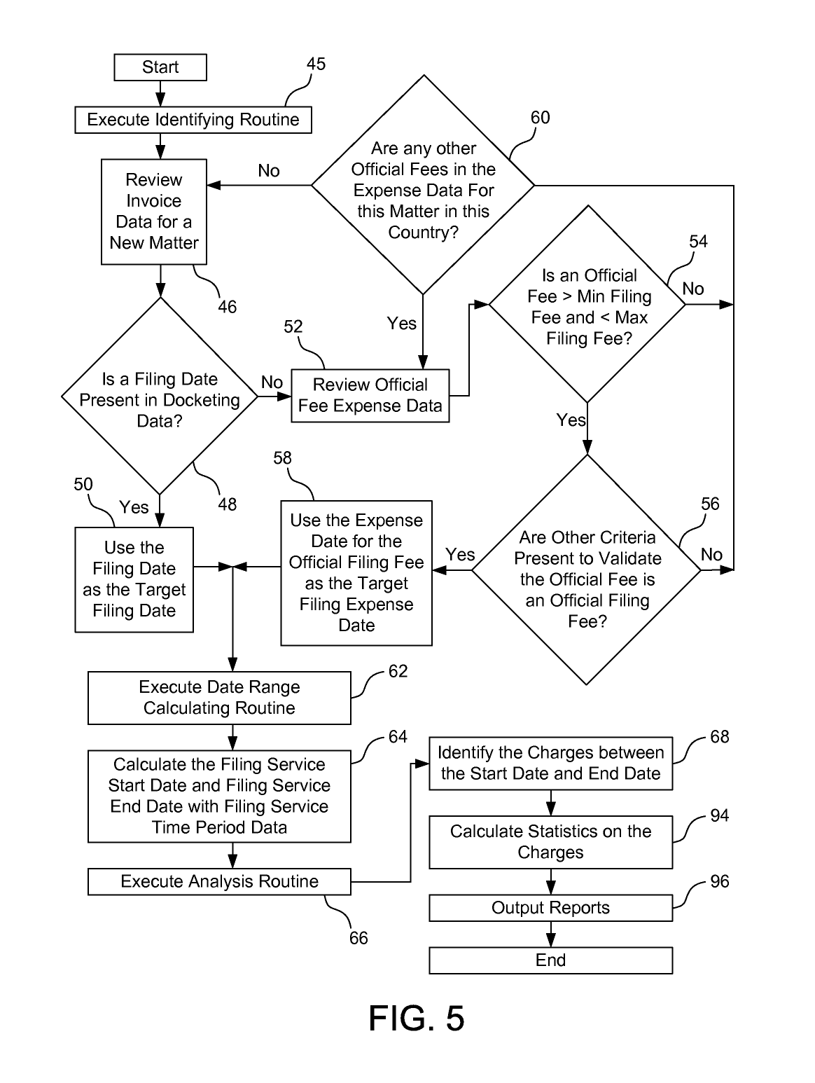

As shown by the flow diagram of FIG. 5, which is exemplary with respect to patent filing services, one aspect of the present invention is an identifying routine 45 that is executed to identify “target” filing dates. This can occur by identifying the appropriate date related to filing in the docketing data for a matter in a country, e.g. a filing date 30. As shown in FIG. 5, the identifying routine 45 reviews invoice data for a new matter in a new country 46. If the identifying routine 45 determines that a filing date for this matter in this country is present in the docketing data 48, then this filing date is used as the target date 50. In yet another aspect of the present invention, it should be noted that the identifying routine 45 can use other sources of information that can identify target dates, such as relevant dates that may be available via public data sources or docketing systems. For example, in many countries a patent application is published 18 months after filing. As such, the identifying routine 45 may use publication dates from a public patent database to identify or validate a filing date.

As further shown in FIG. 5 in another aspect of the present invention, if the identifying routine 45 does not locate a filing date for the matter in the docketing data, the identifying routine 45 reviews the invoice data for the matter in the country 52 and if an official filing fee expense is identified that is greater than a minimum filing official fee and less than a maximum filing official fee 54, then the expense date for this official filing fee could be identified by the routine as a “target” filing expense date, which may be verified or validated by other criteria that the official filing fee is valid 56. If the official filing fee is identified, its charge date can be used as the target date 58. If the official filing fee does not fall between the minimum and maximum filing official fees, or is not properly identified to be valid, the system searches for other official fee expenses related to this matter 60 and processes them in the same way. If there are no other official fee expenses related to that matter, the identifying routine 45 reviews the next new matter in the invoice data 46 and repeats the process until all matters in all countries in the invoice data have been reviewed and all possible target dates have been established for all matters.

The identifying routine 45 may be executed to validate that a target official fee date has been properly identified as set forth in the following exemplary techniques. The identifying routine 45 may compare the target filing expense date for one of the matter identifiers to a target examination expense date for the same matter identifier and verify that the target filing expense date is earlier than the target examination expense date as shown in FIG. 2. In the same manner, the identifying routine 45 may also be executed to validate that a target examination expense date for one matter identifier has been properly identified. Again, the identifying routine 45 may compare the target examination expense date to the target grant expense date for the matter identifier and verify that the target examination expense date is earlier than the target grant expense date as further shown in FIG. 2.

The identifying routine 45 may also include further validation techniques for the identification of a particular target official fee expense charge and a particular target official fee expense date. For example, invoice data may include expense types for translation and translation expenses are commonly associated with filing services. Accordingly, the identifying routine 45 can be further executed to validate that a target filing expense date for one matter identifier has been properly identified by determining if a translation expense charge, with a translation expense type, has a translation expense date between said filing service start date and said filing service end date. If so, there is a strong likelihood that the official fee is in fact a target filing expense charge. Similarly, the system can use other validation techniques such as searching for certain key words in the service description or comparing UTBMS codes to increase the confidence of the result.

Note, the identifying routine 45 can be further executed to identify other target dates in the same manner for services other than filing services 20. For example, if the invoice data has a matter, where the docketing data includes a request exam date 32, this date can be used as the target date for services related to request for exam 22. If a target date is not available in the docketing data, the identifying routine 45 will search for an official examination fee expense in the same manner as described above. As shown in FIG. 5 at step 54, the system uses minimum and maximum official fees to define a range and the identifying routine 45 determines if an official fee expense charge falls within the applicable range. If the official fee expense charge falls within an applicable range, the system identifies it as a target official fee expense charge for the applicable legal service. If the system determines that the expense falls within the minimum and maximum range, and if necessary the system is able to verify the expense as an official fee by, for example, its expense type, this would positively identify that the expense is in fact an official fee and the expense date would be used as a target date. The identifying routine 45 may use similar logic to identify official fee expense charges, such as filing expense charges (as described above), examination expense charges, response expense charges, grant expense charges, annuity expense charges and other expense charges.

Note, the “target” date relating to filing services 20 could be the filing fee due date, the filing date, the actual filing expense date or some similar date. Likewise, the target date relating to a target grant expense charge could be the grant fee due date, the grant date, the target grant expense date or some similar date. Moreover, the target date relating to an examination expense charge could be the examination fee due date, the examination date, the target examination expense date or some similar date. For a patent matter the response date above could also be any one of a response due date, a response filing date, a response fee charge date, a request for examination due date, a request for examination filing date, an examination fee expense date, an appeal due date, an appeal filing date, an appeal fee expense date or some similar date. It should likewise be recognized that the invoice date for the expense or service, rather than the actual service date, could be used in the above determinations, analyses, calculations and the like since the invoice typically follows the service within a month or so. Alternatively, a related custom date can be selected by the system or by a user of the system. Any of the above dates can be identified and found by the system in any known sources of such data such as, for example, the docketing data, the e-billing data, public databases and the like. Moreover, one or more of the above dates can be used to validate or verify any of the other dates listed above. For example, a target date identified in docketing data can be validated against a related target date identified in invoice data, or vice versa.

For the identifying routine 45 to identify official fee expenses, official fee data from various countries should be available. In another aspect of the present invention, official fee data for a plurality of countries can be stored within the process circuitry or accessed from other data sources. This official fee data can likewise be for a plurality of time frames to insure that the official fee data is applicable for the target expense date. Moreover, exchange rate information for a plurality of time frames can be stored or accessed to insure that any necessary conversion of currencies at the target expense date can be taken into consideration. This data can include, for example, minimum filing fees, maximum filing fees, minimum examination fees, maximum examination fees, minimum grant fees and maximum grant fees in each country.

In one aspect of the present invention, the process circuitry can execute an official fee retrieval routine 100 to identify and retrieve official fee data from a website such as a patent office website, and previous versions thereof, or any other source of such data. This enables the system to have historically accurate official fee information for the time frame of the target expense date. In addition the process circuitry can also execute an exchange rate routine 98 to identify and retrieve exchange rate data from a website such as that of a financial institution or financial publication or any other source of such information, including currency exchange rates and exchange rate dates. The exchange rates and exchange rate dates are utilized by said system to convert service charges, expense charges and official fees into another currency that is historically accurate for the time frame of the target expense date.

Continuing now with the filing services example above, if the minimum official filing fee is $1,000 and the maximum official filing fee is $1,200 for an intellectual property application filed in Japan, and the official fee expense charges for a matter in Japan totals $1,100, the identifying routine 45 could identify this expense charge as an official filing fee and could identify the applicable filing fee expense date as the target filing expense date. If desired, the system could perform the validation techniques described above by determining, for example, if the target filing expense was coded as an official fee, the official filing fee was followed by an examination fee and/or there was also a translation charge for that matter.

In another aspect of the invention, the identifying routine 45 can perform steps 54 and 56 in conjunction with one another where the existence of an official fee, regardless of its amount is used as one of the other validation criteria in step 56. For example, all of the other criteria used in step 56, in addition to an official fee falling within the range in step 54, are used as individual criteria. All of the criteria in steps 54 and 56 are given a value and for each criteria that is met, the value for this met criteria is used in the calculation of a weighed value. If the weighted value suggests that enough criteria have been met, the identifying routine can identify the official fee expense date as a target date even though the official fee expense does not fall within the minimum and maximum official fee range. Continuing again with the filing example above, if the official fee expense charges in Japan were $900 and therefore outside the range of $1,000 to $1,200, but enough other criteria were met, the identifying routine would identify the official fee expense as a target expense and therefore the official fee expense date would be identified as the target expense date.

Note that the identifying routine 45 may use an individual official fee charge in step 54 to determine if the official fee charge is within the minimum and maximum official fee range. In addition, the identifying routine 45 may also use multiple official fee charges having the same expense date. In the case of multiple official fee charges on the same date, the identifying routine 45 can sum the official fee charges and use the sum of the official fee charges in order to then determine if the sum is within the minimum and maximum official fee range.

Once target expense dates are established for all applicable official fees, a date range calculating routine 62 may be executed to calculate one or more pairs of start dates and end dates for one or more services associated with each applicable target date 64. Continuing again with the filing service example above, now that a target filing expense date has been identified, the date range calculating routine 62 can be executed to calculate a filing service start date and a filing service end date for the matter. The date range calculating routine 62 can perform its calculation by taking the target filing expense date and applying the filing services time period data to determine a filing service start date and a filing service end date for a matter. For example, if the target filing expense date for matter identifier 13/111,222 in Japan is Jul. 1, 2014 and the filing service time period data for this type of intellectual property in Japan is a time period beginning four months prior to the target filing expense date and ending three months after the target filing expense date, then the date range calculating routine 62 would set the filing service start date at Mar. 1, 2014 and the filing service end date at Oct. 1, 2014.

Note, as shown in FIG. 3, the date range calculating routine 62 can be further executed to calculate other start and end dates for a variety of services, including a pre-examination service start date 70 and a pre-examination end date 72, an examination service start date 74 and an examination service end date 76 based upon a target examination expense date 32 and the examination services time period data. The date range calculating routine 62 can be further executed to calculate a grant service start date 82 and a grant service end date 84 based upon a target grant expense date 36 and grant services time period data.

It should likewise be noted that other similar ranges can be established for other services based upon the same target filing expense date. For example, if it is desired to analyze a specific service and the time when said specific service is performed can be correlated to an expense, a service start date and a service end date can be calculated for that service and the expenses within that time period analyzed. For example, if one wanted to examine the service charges related to communications under EPC Rule 161 and one knew that a response to the EPC Rule 161 communication was due about 6 months after the target filing expense date, one can calculate a 161 service start date using time period data as follows. The 161 service start date can be calculated as 5 months prior to a date six months after the target filing expense date and a 161 service end date can be calculated as 2 months after a date six months after the target filing expense date. It should also be noted that date ranges can be adjusted based on experience and individual billing practices. For example a date range may be expanded or shortened by a certain time period around certain target official fee dates and/or for certain countries and/or for certain agents. Finally, in another aspect of the invention, an open ended date range can be calculated where all services occurring prior to a date or all services occurring after a date are included. For example, the time period could be used to identify all charge occurring prior to the filing start date.

In some instances date ranges may actually overlap. For example, the service of reporting a patent publication may fall within a date range for another service such as pre-examination or requesting examination. In this instance, it is important to make certain the charges associated with two different services in an overlapping date range are not double counted. In these instances, the date range calculating routine 62 automatically excludes charges relating to a one service from the date range of another service based upon a description of the service, a service type, expense type, UTBMS code or the like that positively differentiates the excluded charges from being a part of the service for which the date range is calculated.

The date range calculating routine 62 can also allow for automated manipulation of date ranges that inadvertently overlap. For example, if the filing service end date and the examination service start date overlap because examination services were performed early, the date range calculating routine 62 can automatically reset both dates to another date, e.g., a date that is half way in between the two overlapping dates. Alternatively, if dates are overlapping, the system can force all of the charges between the overlapping dates to be included in only one of the two overlapping date ranges.

In addition, the system can also allow for manual manipulation of specific service charges. For example, if a user of the system reviews the service description for a service charge and the system included it as part of the wrong service, a manual override setting can be used to force the service charge into the appropriate service.

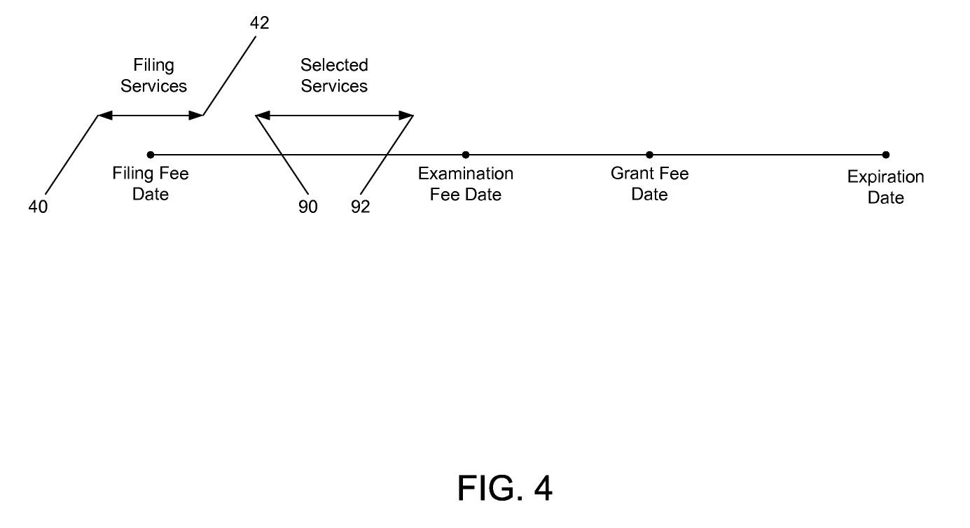

Once the date range calculation routine establishes start dates and end dates for the applicable services being performed, an analysis routine 66 can be executed to identify service and expense charges for a matter in a country having service and expense dates between the applicable start date and the end date 68. As best shown in exemplary FIG. 3, these start dates and end dates can be, for example, the filing service start date 40 and the filing service end date 42 for filing services, the pre-examination service start date 70 and the pre-examination end date 72 for pre-examination services, the examination service start date 74 and the examination service end date 76 for exam services, the response service start date 78 and the response service end date 80 for response services, the grant service start date 82 and the grant service end date 84 for grant services, and the annuity service start date 86 and the annuity service end date 88 for annuity services. Alternatively, as best shown in FIG. 4, the start and end date may include a selected start date 90 and a selected end date 92, where a user of the system chooses the start and end date based upon their own selected date criteria. In one aspect of the invention, the system is flexible and the start date and end date may be any combination of the above dates.

Referring again to FIG. 5, statistical calculations can be performed on the charges identified for the matter and such statistics can be generated by categories 94. For example, summation, averaging, determining highs and lows, or the like can be calculated for service and expense charges by agent, by country, by service and the like. For example, summing charges for services between a selected service date before the filing service start date and the filing service start date 40 will provide the total service charges, if any, a service provider is charging prior to the time period when filing services should begin. These charges should be minimal since filing activities should not have started yet. Similarly, summing charges for services between the filing services start date 40 and the filing services end date 42 will provide the total service charges a service provider is charging for filing.

Continuing the filing service example above, if the filing service start date 40 for matter identifier 13/111,222 in Japan was Mar. 1, 2014 and the filing service end date 42 for this matter was Oct. 1, 2014 and the system identified that an agent had ten service charges for this matter, all with service dates between Mar. 1, 2014 and Oct. 1, 2014, totaling a sum of $6,000, then the analysis routine 66 could automatically calculate this sum of $6,000 for matter identifier 13/111,222 in Japan, for that agent. The analysis routine accurately transforms data that is returned regardless of whether the actual billing data contained inaccurate descriptions of services or inaccurate service type and expense type coding. The system can increase the confidence that the service charges within the range are correct by, for example, searching for certain key words in the service description that are associated with the service or reviewing the UTBMS codes to determine if they are associated with the service, however, this is not necessary. Note, the system can also search for certain key words in the service description in order to exclude such service charges from the date range as well.

Similar to the example above, summing charges for services between the filing services end date 42 and the examination services start date 74 will provide an agent's total service charges for pre-examination activities. Again, these charges should be minimal since filing is complete and substantive examination has not yet begun. Summing charges for services between the examination services start date 74 and the examination services end date 76 will provide an agent's total service charges for initiating examination activities. Summing charges for services between the response services start date 78 and the response services end date 80 will provide an agent's total service charges for response services. Summing charges for services between the grant services start date 82 and the grant services end date 84 will provide an agent's total service charges for handling the grant. Summing charges for services between the grant services end date 84 and a selected service date after the grant service end date will provide an agent's total service charges for post-grant activities. Typically, these charges should be minimal since there has already been a grant.

As mentioned above, a user of the system can enter a selected date or dates 90 and 92 into the system, which can be used as a start or end date. The analysis routine 66 can be executed to sum the service charges for one of the matter identifiers having service dates between the selected dates 90 and 92 or between one selected date and any one of other dates mentioned in the preceding paragraphs. A practical example of using a selected date would be if a user of the system would like to calculate what service providers are charging for responding to an EPC Rule 161/162 notification. A response to this notification is typically filed within six months of the filing service end date. As such, a user can select the filing service end date as a start date and an end date that is six months after the filing service end date. The system will sum the charges for all applicable European matters and calculate the average charge during this six month period following the filing service end date. Typically, responding to an EPC Rule 161/162 notification is the only service that is required during this time period. The system can then calculate the average charge for responding to an EPC Rule 161/162 notification, as well as the average charge by each service provider for this service.

The results of the above identification and, if desired, calculation can be output by the system 96 in a wide variety of ways. For example, if the system calculates a sum for the same service on a number of matter identifiers for a number of service providers, the system can calculate an average charge for this service in a given country. Similarly, the system can calculate the average charge for a service by each service provider. The system can then generate benchmarking reports that compare these average charges. For example, the system can compare the charges for one country with the charges for another. Likewise, the system can compare the service charges for one service provider in a country with other service providers, or with the average service charge for a service in a country. Additionally, if desired, the system can allow for manipulation of data to be included or excluded from these calculations to insure that incorrect or incomplete data is not used. In this way, a user can determine the most cost effective service providers.

The system output 96 of the identified and calculated data can be provided in a number of formats. For example, the output can be in the form of paper or electronic lists or reports, paper or electronic graphs, dashboards, or the like. These outputs can be static or users/viewers can interface with the results to produce the most relevant or useful output.

It should be noted that the system outputs can be combined and/or integrated with the output or files from other systems. For example, the output of a list of charges for a given time period can be combined with selected or related prosecution history documents from, for example, a docketing system, a publically available data source such as PAIR, ESPACENET, file folders on servers or the like. In this manner, the system can more clearly correlate charges, or groups of charges, with the services that were provided.

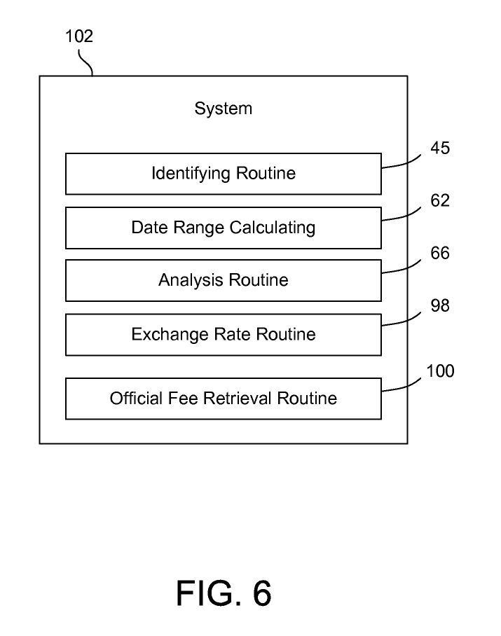

FIG. 6 is a schematic block diagram of one embodiment of a system for analyzing electronic invoice data. The system includes a computer readable storage medium 102 with a plurality of routines. Aspects of the various routines are discussed above.

Although a single block is shown in FIG. 6 to represent the computer readable storage medium, other embodiments may store the routines on a plurality of media. In this way, the routines may be at least partially distributed across different media. Additionally, in some embodiments, some or all of the routines may be distributed across two or more computer devices or processors.

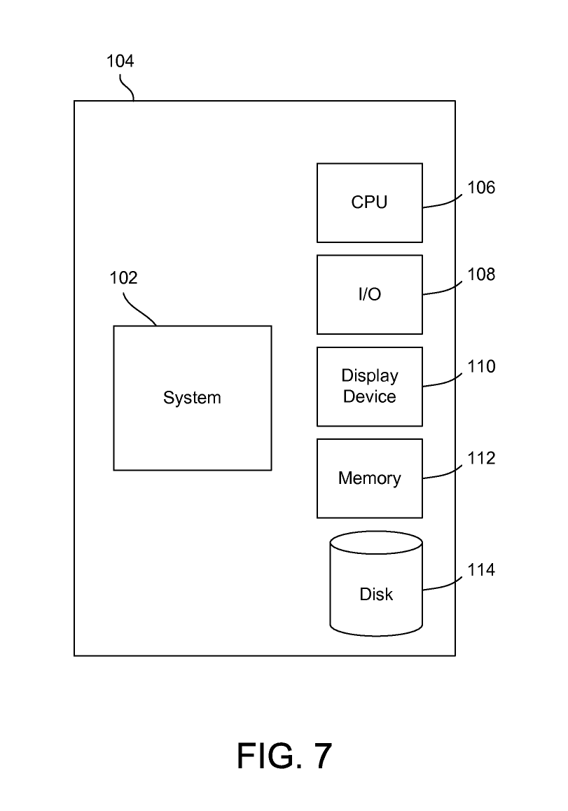

FIG. 7 is a schematic block diagram of one embodiment of a computer architecture 104 to implement the system of FIG. 6. Although the illustrated architecture 104 includes certain components with functionality described herein, other embodiments of computer architectures suitable for implementing aspects of the inventions described herein may include fewer or more components to achieve less or more functionality.

The depicted architecture 104 includes the computer readable storage medium 102 of FIG. 6. The architecture 104 also includes a processor 106 to execute one or more of the routines stored on the storage medium 102. Alternatively, multiple processes may distribute or otherwise share the processing load of one or more routines. The architecture also includes one or more input/output (I/O) devices 108. The I/O devices may be any form of input devices configured to accept input from a user or from another device. The I/O devices also may be any form of output devices configured to receive a communication signal or other form of data from the architecture. A specific type of output device is a display device 110. The display device may be used to convey graphical or other visual information to a user in response to processing steps executed by the processor.

The illustrated architecture also includes a memory device 112. The memory device may be any type of device that temporarily or permanently stores data, including but not limited to cache devices such as on-die cache or separate cache devices. The architecture also includes a storage device 114 or disk or other device connected to the processor to store data in a non-volatile manner. Other embodiments may include other forms of memory and/or storage devices capable of storing data and/or programming instructions to be used by the processor or other processing resources.

It should be noted that the system and the above exemplary techniques can be used on both a static compilation of invoice and docketing data or on a set of invoice and docketing data that is intermittently updated or continuously updated. For example, the system could run the above routines after each update of the invoice data to determine if additional charges have been included in a target date range. Similarly, the system could run the above routines on a real time basis such that as the data set is updated, the system identifies whether a new target date has been identified and initiates one or more of the routines. For example, an official fee expense could trigger the date range calculating routine 62 to calculate a service start date and a service end date based upon the time period data and the official fee date. As the data sets are updated and the end date is reached, the analysis routine 66 could automatically execute to identify, sum and report all of the service charges for the matter identifier to a user of the system.

Moreover, the system of the present invention could be run on a “real-time” basis such that when an electronic communication containing a target date is sent to an applicant (e.g., an E-Office action from the USPTO, an input into the USPTO PAIR system, or a communication from a law firm), an action in the system could be initiated. For example, an electronic communication containing a target date could execute the date range calculating routine 62 to calculate the service start date and the service end date based upon the service time period data and the target date. Once the service end date is reached, the analysis routine 66 could automatically execute to identify the service charges for the matter.

In one additional embodiment, the system of the present invention could be run on a “real-time” basis such that when a fee such as an official fee is detected, it initiates an action outside of the system of the invention. For example, detecting an official fee could prompt an enterprise software application such as SAP® to prepare a payment for the fee and/or an agreed service charge to the appropriate agent.

In another embodiment, the above routines could be run on incomplete data sets to monitor the billing trends. For example, if total charges for a matter are out of an acceptable range, the analysis routine could trigger the generation of a report or warning even though a target date has not yet been established for that matter. In another example, the system may identify a target date, calculate a target date range and begin including expenses accrued during the target date range. If, during the accrual process, the sum of charges exceeds a predetermined amount, an exception report can be automatically triggered by the analysis routine. This report can be used, for example, to more closely supervise or warn the service provider.

The system of the invention could detect and/or summarize service fees that are deemed undesirable or unwanted by a patent applicant. For example, in the USA charges for extensions of time and requests for continued examination (RCEs) can be an indicator of inefficient operations. Official fee information relating to filing an extension of time or an RCE can be used by the system as set forth above to identify if an RCE or an extension of time has been filed. The analysis routine 66 could be executed to sum the number and/or total cost of such fees for, for example, a given service provider. Similarly, the system could use key word searching in the service fee descriptions to verify that the charges in fact related to the filing of an extension of time or an RCE as set forth above. Such results of the system of the invention could be used in evaluating the cost effectiveness of service providers.

The system of the invention can calculate the costs surrounding charges other than official fees. For example, if one were to know an agent's charge for performing a prior art search, one could execute the identifying routine to identify a target fee search expense in order to identify the target search date and select a date range around the target search date to calculate an agent's charge for interpreting the search results. Again, the system could also use key word searching in place of, or as a supplement to, these techniques.

One of the benefits of the system of at least one embodiment of the present invention is that you do not need years of billing data in order to determine what agents are charging for specific services. For example, by breaking the patent prosecution life cycle down into multiple discrete time periods, multiple patent applications can be analyzed over a short period of time, yielding results for each time period. The results of each time period can, for example, then be summed to determine what each agent is charging on average over the prosecution life cycle of a typical patent application. Hence with relatively smaller amounts of data, patent agent charges can be accurately benchmarked for the full range of services and their associated charges despite the lengthy patent prosecution life cycle.

On the other hand, if one does have data for a longer time frame, the system can readily discern information about billing practices. For example, one can observe patterns of billing over one or more target service date ranges as described above for an individual matter. Similarly, one can observe patterns of billing for a plurality of matters for a given client, service provider or the like.

An additional benefit that some embodiments of the present invention have over e-billing systems is that some embodiments of the present invention do not simply average charges over time. When simply averaging charges over time, applications that were abandoned or only partially completed during the applicable time period can dramatically skew the results of the cost analysis. Some embodiments of the present invention only analyze charges where an official fee was paid. By definition, this means that the services associated with the official fee were completed. However, other embodiments may establish analysis parameters based on other discrete events, such as official mailing or receipt dates recorded with the corresponding administrative office.

While most of the examples provided above relate to patent prosecution, the system of the present invention can be readily used with trademark matters, or other matters, utilizing the same system and routines. Costs can be determined relating to search services performed prior to filing trademarks, filing services for trademarks, handling of the grant or “registration” of a trademark, paying renewal fees and the like. The functionality of the system applies.

In one embodiment, the system of the present invention and portions thereof may be integrated into a system for managing the legal matters, such as that described in PCT Application No. PCT/US2007/064062 entitled “METHOD AND SYSTEM FOR MANAGING LEGAL MATTERS,” filed on Mar. 15, 2007, the entire disclosure of which is incorporated herein by reference. In an alternative embodiment, the system of the present invention and portions thereof may also be integrated into and used in conjunction with a system for managing legal service providers, such as that described in PCT Application No. PCT/US2008/79805 entitled “SYSTEM AND METHOD FOR MANAGING LEGAL SERVICE PROVIDERS” filed on Oct. 14, 2008, the entire disclosure of which is incorporated herein by reference. In an alternative embodiment, the system of the present invention and portions thereof may also be integrated into and used in conjunction with patent life cycle management system, such as that described in PCT Application No. PCT/US2013/027343 entitled “PATENT LIFE CYCLE MANAGEMENT SYSTEM” filed on Feb. 22, 2013, the entire disclosure of which is incorporated herein by reference. When integrated into this later system, the system of the present invention could put at the user's fingertips the ability to readily select certain agents and/or countries for filing based on up to date total actual costs and, thereafter, initiate the filings.

In addition, the system of the present invention or portions thereof may be integrated into conventional docketing systems such as those identified above. For example, the routine entry of dates for docketing purposes could trigger the identifying, date range calculating and/or analysis routines of the system on a real time basis. Alternatively, for example, a docketing software could be accessed by the system to supply target dates. In yet another example, the system of the invention could provide data to the docketing software such as service charges. In this way, a service charge could be automatically and immediately associated with the matter in the docketing system.

Likewise, the system of the present invention or portions thereof may be integrated into other known systems for managing matters such as e-billing software from TyMetrix, Serengeti, DataCert, CounselLink and the like. The system can be used in such software to analyze historical data or, if desired, analyze data on a real time basis. For example, the system of the present invention could calculate and automatically integrate “Not To Exceed” (NTE) rates for selected services or service time frames, thus flagging or inhibiting payments in excess of such NTE rates. Alternatively, the outputs of the system of the present invention can be used in outside counsel management discussions and decisions.

Similarly, the system of the present invention or portions thereof may be integrated into budgeting software, systems or calculations or enterprise software applications so that a managing counsel could more accurately predict their costs in future budgetary cycles. Alternatively, the results of the system of the present invention can be used in such systems or software in evaluating and deciding whether the return on the average cost of a patent filing (as calculated by the system) justifies a filing in a given country.

In yet another embodiment, the system of the present invention, or portions thereof, can be integrated into software that performs more than one of the above functions of docketing, e-billing, matter management or budgeting to achieve synergistic efficiencies, such as the system commonly available from Anaqua. Moreover, other systems could be integrated such as conventional agreement management systems and other software conventionally used by intellectual property professionals.

It is to be understood that variations and modifications can be made on the aforementioned structure without departing from the concepts of the present invention, and further it is to be understood that such concepts are intended to be covered by the following claims unless these claims by their language expressly state otherwise.

1. A system for analyzing electronic invoice data related to intellectual property matters comprising:
process circuitry configured to store data, wherein the data comprises:
invoice data comprising service charges, service dates, expense charges, expense dates, and matter identifiers;
official fee data stored within said process circuitry comprising a minimum fee and a maximum fee; and
service time period data stored within said process circuitry;
wherein the process circuitry is further configured to execute routines, wherein the routines comprise:
an identifying routine to identify target expense dates for target expense charges having a total between said minimum fee and said maximum fee;
a date range calculating routine to calculate a service start date and a service end date based upon said service time period data and said target expense dates; and
an analysis routine to identify said service charges for at least one of said matter identifiers having said service dates between said service start date and said service end date.

2. (canceled)

3. The system of claim 1 wherein the fee data is official fee data and is selected from the group consisting of a minimum filing fee, a maximum filing fee, a minimum examination fee, a maximum examination fee, a minimum response fee, a maximum response fee a minimum grant fee, a maximum grant fee and combinations thereof.

4. The system of claim 1 wherein the identifying routine is executed at least once to perform an identification selected from the group consisting of identifying target filing expense dates for target filing expense charges having a total between a minimum filing fee and a maximum filing fee; identifying target examination expense dates for target examination expense charges having a total between a minimum examination fee and a maximum examination fee; identifying target response expense dates for target response expense charges having a total between a minimum response fee and a maximum response fee; identifying target grant expense dates for target grant expense charges having a total between a minimum grant fee and a maximum grant fee; and combinations thereof.

5. The system of claim 1 wherein the service time period data is selected from the group consisting of filing service time period data, pre-examination service time period data, request for examination service time period data, PPH service time period data, response service time period data, grant service time period data, annuity service time period data and combinations thereof.

6. The system of claim 5 wherein the date range calculating routine is executed to perform a calculation selected from the group consisting of calculating a filing service start date and a filing service end date based upon said filing service time period data and a date relating to a target filing expense charge; calculating an examination service start date and an examination service end date based upon said examination service time period data and a date relating to a target examination expense charge; calculating a response service start date and a response service end date based upon said response service time period data and a date relating to a target response expense charge; calculating a grant service start date and a grant service end date based upon said grant service time period data and a date relating to a target grant expense charge; and combinations thereof.

7. The system of claim 6 wherein the analysis routine is executed to perform an identification selected from the group consisting of identifying said filing service charges for at least one of said matter identifiers having said filing service dates between said filing service start date and said filing service end date; identifying and summing said examination service charges for at least one of said matter identifiers having said examination service dates between said examination service start date and said examination service end date; identifying and summing said response service charges for at least one of said matter identifiers having said response service dates between said response service start date and said response service end date; identifying and summing said grant service charges for at least one of said matter identifiers having said grant service dates between said grant service start date and said grant service end date; and combinations thereof.

8. The system of claim 1 wherein said invoice data is for a plurality of countries and the invoice data further comprises data selected from the group consisting of country identifiers, agent names and combinations thereof and wherein the invoice data includes expense types and said identifying routine identifies target filing expense charges, target examination expense charges target response expense charges and target grant expense charges by identifying said expense charges having an official fee expense type.

9. The system of claim 7 wherein said identifying routine is further executed to validate an expense date for one of said matter identifiers, said validation selected from the group comprising (i) validating that a target filing expense date for one of said matter identifiers has been properly identified by said identifying routine, said identifying routine comparing said target filing expense date for said one of said matter identifiers to a target examination expense date for said one of said matter identifiers and verifying that said target filing expense date for said one of said matter identifiers is earlier than said target examination expense date for said one of said matter identifiers (ii) validating that a target examination expense date for one of said matter identifiers has been properly identified by said identifying routine, said identifying routine comparing said target examination expense date for said one of said matter identifiers to a target grant expense date for said one of said matter identifiers and verifying that said target examination expense date for said one of said matter identifiers is earlier than said target grant expense date for said one of said matter identifiers and (iii) utilizing other data related to said one of said matter identifiers selected from a group comprising: UTBMS codes; inclusion of certain key words in a service description; inclusion of certain key words in an expense description; the exclusion of certain key words from said expense description; the exclusion of certain key words from said service description; and combinations thereof.

10. (canceled)

11. The system of claim 7 wherein said analysis routine further sums said expense charges having said expense dates between any pair of said filing service start date, said filing service end date, said examination service start date, said examination service end date, said response service start date, said response service end date, said grant service start date and said grant service end date and wherein said analysis routine further sums said service charges having said service dates between any pair of dates selected from a group comprising: a selected service date before said filing service start date and said filing service start date, said filing service start date and said filing service end date, said filing service end date and said examination service start date, said examination service start date and said examination service end date, said examination service end date and said response service start date, said response service start date and said response service end date, said response service end date and said grant service start date, said grant service start date and said grant service end date, said grant service end date and a selected service date after said grant service end date.

12. (canceled)

13. The system of claim 11 wherein said analysis routine is further executed to calculate an average sum of service charges for a plurality of said matter identifiers having service dates between one of said pair of dates in said group.

14. The system of claim 7 wherein said invoice data further includes expense types for translation and said analysis routine is further executed to validate that a target filing expense date for one of said matter identifiers has been properly identified by said identifying routine, said analysis routine is executed to verify a translation expense charge, for said one of said matter identifiers having a translation expense type, has a translation expense date between said filing service start date and said filing service end date for said one of said matter identifiers.

15. The system of claim 7 wherein said process circuitry executes a routine selected from the group comprising (i) an official fee retrieval routine to retrieve official fee data from a website and (ii) an exchange rate routine to retrieve exchange rate data from a website, including currency exchange rates and exchange rate dates, said exchange rates and said exchange rate dates are utilized by said system to convert said service charges, said expense charges and said official fees into another currency.

16. (canceled)

17. (canceled)

18. The system of claim 9 wherein said analysis routine is further executed to calculate an average sum of said identified service charges for a plurality of said matter identifiers for a group comprising: a selected country; a selected agent; and a selected service.

19. A system for analyzing electronic invoice data related to intellectual property matters comprising:
process circuitry configured to store data, wherein the data comprises:
invoice data comprising service charges, service dates and matter identifiers stored within said process circuitry;
docketing data comprising said matter identifiers and at least one target date for said intellectual property matters stored in said process circuitry; and
service time period data stored within said process circuitry;
wherein the process circuitry is further configured to execute routines, wherein the routines comprise:
a date range calculating routine to calculate a service start date and a service end date based upon said service time period data and said target date; and
an analysis routine to identify said service charges for at least one of said matter identifiers having said service dates between said service start date and said service end date.

20. The system of claim 19 wherein the invoice data is for a plurality of countries and the invoice data further comprises data selected from a group comprising: expenses charges; expense dates; country identifiers; agent names; and combinations thereof.

21. The system of claim 19 wherein the docketing data is obtained from a source selected from a group comprising: docketing databases; matter management databases; public databases; and combinations thereof.

22. The system of claim 19 wherein the service time period data is selected from a group comprising: filing service time period data; pre-exam service time period data; request for examination service time period data; PPH service time period data; response service time period data; grant service time period data; and combinations thereof and wherein the date range calculating routine is executed to perform a calculation selected from a group comprising: calculating a filing service start date and a filing service end date based upon said filing service time period data and a target filing date; calculating a pre-exam service start date and a pre-exam service end date based upon said pre-exam service time period data and a target pre-exam date; calculating an examination service start date and an examination service end date based upon said request for examination service time period data and a target examination date; calculating a response service start date and a response service end date based upon said response service time period data and a target response date; calculating a PPH service start date and a PPH service end date based upon said PPH service time period data and a target PPH date; calculating a grant service start date and a grant service end date based upon said grant service time period data and a target grant date; and combinations thereof.

23. (canceled)

24. The system of claim 22 wherein the analysis routine is executed to identify data from a group comprising: identifying target filing service charges between said filing service start date and said filing service end date; identifying target pre-examination service charges between said pre-examination service start date and said pre-examination service end date; identifying target examination service charges between said examination service start date and said examination service end date; identifying target PPH service charges between said PPH service start date and said PPH service end date; identifying target response service charges between said response service start date and said response service end date; identifying target grant service charges between said grant service start date and said grant service end date; and combinations thereof.

25. The system of claim 19 wherein the analysis routine further performs a summation selected from a group comprising: summing the identified filing service charges for at least one of said matters; summing the identified pre-examination service charges for at least one of said matters; summing the identified examination service charges for at least one of said matters; summing the identified PPH service charges for at least one of said matters; summing the identified response service charges for at least one of said matters; summing the identified grant service charges for at least one of said matters; and combinations thereof.

26. The system of claim 19 wherein a target filing date is selected from a group comprising: a filing fee due date; a filing date; a filing deadline date and a target filing expense date; and a target examination date is selected from a group comprising: a response due date; a response filing date; a response fee charge date; a request for examination due date; a request for examination filing date; and an examination fee expense date; and a target grant date is selected from a group comprising: a grant fee due date; a grant date; and a target grant expense date.

27. The system of claim 25 wherein said analysis routine is further executed to calculate an average sum of said identified service charges for a group comprising: a plurality of said matter identifiers; a plurality of matter identifiers for a selected country; and a plurality of matter identifiers for a selected agent.

28. (canceled)

29. (canceled)

30. (canceled)

31. A method for analyzing electronic invoice data, the method comprising:
accessing invoice data stored in memory, the invoice data comprising a matter identifier with service charges and service dates;
identifying a target date associated with the matter identifier and a service associated with the target date;
accessing service time period data stored in the memory for the identified service;
calculating a service start date and a service end date based on the service time period data and the target date;
identifying from the invoice data the service charges between the service start date and the service end date; and
storing a record in the memory to correlate the at least one service with each of the identified service charges between the service start date and the service end date.

32. The method of claim 31 wherein the target date associated with the matter identifier is identified by a process selected from a group comprising (i):
accessing expense charges and expense dates within the invoice data;
accessing official fee data stored within the memory, wherein the official fee data comprises a minimum fee and a maximum fee for at least one service;
identifying a target expense date from the expense dates based on a determination that a corresponding expense charge is between the minimum fee and the maximum fee of the official fee data; and
designating the target expense date as the target date
and (ii):
accessing docketing data associated with the matter identifier;
identifying a target docketing date from the docketing data based on an association between the target docketing date and the at least one service; and
designating the target docketing date as the target date.

33. (canceled)

34. (canceled)
